(19) United States
(12) Patent Application Publication
(10) Pub. No.: US 2019/0357580 A1
(43) Pub. Date: Nov. 28, 2019

(54) LOW-CALORIE SWEETENER COMBINATION COMPOSITIONS

(71) Applicant: SUCRAZIT LTD., Rosh-Ha'ayin (IL)

(72) Inventor: Lior LEVY, Tel Aviv (IL)

(73) Assignee: SUCRAZIT LTD., Rosh-Ha'ayin (IL)

(21) Appl. No.: 16/316,713

(22) PCT Filed: Jul. 31, 2018
(86) PCT No.: PCT/IL2018/050853

§ 371 Date: Jan. 10, 2019

Related U.S. Application Data
(60) Provisional application No. 62/648,955, filed on Mar. 28, 2018.

(51) Int. Cl. A23L 27/30; A23L 29/00; A23L 2/60; A21D 2/18

(52) U.S. Cl. CPC A23L 27/34; A23L 29/015; A23V 2002/00; A21D 2/181; A23L 2/60

(57) ABSTRACT

Sweetener compositions combining fructose, a caloric sugar, with erythritol, a non-caloric sugar alcohol, are provided. The sweetener compositions maintain the taste and feel of conventional sugars, but with reduced amount of calories, and with neither artificial sweeteners nor high intensity sweeteners.

### FIELD OF THE INVENTION

The present invention relates to low-calorie sweetener combination compositions containing fructose and erythritol, preferably in equal parts. In particular, the compositions are free of any high intensity or artificial sweeteners.

### BACKGROUND OF THE INVENTION

Increasing evidence associating excess consumption of sugars such as glucose, sucrose and fructose with obesity, diabetes and various chronic diseases have led to growing interest in sugar substitutes which are low or non-caloric. In particular, the aim is to provide sugar substitutes with the taste and feel of conventional sugars but with reduced level of calories, and preferably with no negative effect on the teeth or blood sugar levels.

Various artificial and natural sugar substitutes have been proposed and used. High intensity sweeteners are a group of widely used sugar substitutes characterized by sweetness that is many times the sweetness of sucrose (the common table sugar), with no or low caloric content. Most high intensity sweeteners are artificial, including for example, saccharin, aspartame, acesulfame potassium (Ace-K) and sucralose, but a few are natural, for example steviol glycosides originating from the leaves of stevia plants.

While high intensity sweeteners are typically several hundred or even several thousand times sweeter than sucrose, their taste profile is different from that of conventional sugars and they often exhibit bitter and liquorice aftertastes. Thus, commercial food products and sweetener compositions containing high intensity sweeteners typically further include other sweeteners and/or flavor enhancers, taste modifiers and the like, to improve the overall taste and mouthfeel. Among others, sugar alcohols such as erythritol, mannitol, xylitol, and sorbitol are commonly added to products made with high intensity sweeteners.

U.S. Pat. No. 8,993,027 discloses a tabletop sweetener composition comprising at least one natural high-potency sweetener (NHPS) composition in combination with at least one bulking agent, at least one sweet taste improving composition, at least one anti-caking agent, or combinations thereof.

US 2017/0280758 discloses sweetener compositions that after reaction with a carrier precursor and a catalyst are sweeter than the same composition prior to treatment. The sweetener compositions comprise one or more sweetener carbohydrates and/or sweetener polyols and a carrier compound after reaction with a catalyst. Carrier compounds according to US 2017/0280758 may include, for example, silica and silicon dioxide. No compositions having specific combinations of a caloric sugar with a non-caloric sugar alcohol are disclosed or suggested.

Low calorie sweetener compositions with improved taste and which are simple to manufacture are highly desirable. In particular there is an unmet need for reduced calorie sweeteners made of natural ingredients without artificial sweeteners or high intensity sweeteners.

### SUMMARY OF THE INVENTION

The present invention provides according to some aspects low-calorie sweetener compositions combining fructose and erythritol. The present invention discloses that the combination of fructose, a caloric sugar, with erythritol, a non-caloric sugar alcohol, in a 1:1 weight ratio, results in a sweetener composition which maintains the taste and feel of conventional sugars, but with reduced amount of calories. Advantageously, erythritol is 60-70% as sweet as sucrose yet it is non-caloric, does not affect blood sugar and does not cause tooth decay.

Surprisingly, the taste and feel of conventional sugars are obtained even though the compositions do not include high intensity sweeteners or ingredients that enhance sweetness, as in hitherto described low-calorie sweetener compositions.

The present invention therefore provides sweetener compositions with reduced caloric content and with neither artificial sweeteners nor high intensity sweeteners which are cost effective and simple to manufacture.

The sweetener compositions disclosed herein are in a powder form and can be used to sweeten foods and beverages while adding fewer calories compared to conventional sugars.

According to one aspect, the present invention provides a sweetener composition in a powder form, consisting essentially of:

49%-49.95% (w/w) fructose;

49%-49.95% (w/w) erythritol, wherein the fructose and erythritol are present in the composition at a 1:1 weight ratio; and

0.1%-2% (w/w) anti-caking agent.

In some embodiments, the sweetener composition consists of:

49.5%-49.95% (w/w) fructose;

49.5%-49.95% (w/w) erythritol, wherein the fructose and erythritol are present in the composition at a 1:1 weight ratio; and

0.1%-1% (w/w) anti-caking agent.

In some embodiments, the sweetener composition consists of 49.95% (w/w) fructose, 49.95% (w/w) erythritol, and 0.1% anti-caking agent.

In some embodiments, a sweetener composition in a powder form is provided, comprising:

40%-60% (w/w) fructose;

40%-60% (w/w) erythritol; and

up to 2% anti-caking agent,

wherein the fructose and erythritol are the sole sweetening agents in the composition.

In some embodiments, the sweetener composition consists of 40%-60% (w/w) fructose, 40%-60% (w/w) erythritol and up to 1% anti-caking agent.

In some embodiments, the sweetener composition consists of 40%-60% (w/w) fructose, 40%-60% (w/w) erythritol and up to 0.1% anti-caking agent.

In some embodiments, a sweetener composition in a powder form, comprising:

40%-60% (w/w) fructose;

40%-60% (w/w) erythritol; and

up to 2% anti-caking agent,

wherein the composition is devoid of high intensity sweeteners.

The term “anti-caking” agent refers to an additive added to powdered compositions to reduce or prevent the formation of aggregates (lumps).

In some embodiments, the anti-caking agent is silicone dioxide.

The sweetener compositions disclosed herein are devoid of high intensity sweeteners. In some embodiments, the sweetener compositions disclosed herein consist of fructose and erythritol as the sole sweetening agents.

In some embodiments, the sweetener composition is packaged as an individual serving of 1-5 gr. total weight. In other embodiments, the sweetener composition is packaged as a bag of 0.5-1 kg. total weight.

According to a further aspect, the present invention provides a food product sweetened with the sweetener composition of the present invention.

In some particular embodiments, the food product is a beverage.

In additional particular embodiments, the food product is a pastry.

These and further aspects and features of the present invention. will become apparent from the detailed description, examples and claims which follow.

### DETAILED DESCRIPTION OF THE INVENTION

The present invention provides according to some aspects sweetener compositions composed of fructose and erythritol as the sweetening agents. In some embodiments, the fructose and erythritol are present in the composition at a 1:1 weight ratio. It was found that the 1:1 weight ratio between the fructose and erythritol provides a sweetener composition with a palatable sweet taste that highly resembles that of the common table sugar, but with half the amount of calories.

The sweetener compositions disclosed herein are characterized by reduced calories compared to equivalent compositions containing only fructose as the sweetening agent.

Surprisingly, the sweetener compositions disclosed herein maintain the taste and feel of conventional sugars such as sucrose, even though the compositions do not include high intensity sweeteners or ingredients that enhance sweetness, as in hitherto described low-calorie sweetener compositions.

High intensity sweeteners are food-grade substances characterized by higher sweetness per unit mass compared to sucrose with comparatively less calories. High intensity sweeteners include artificial, chemically-synthesized, sweeteners, for example: saccharin, aspartame, acesulfame potassium (Ace-K), sucralose, neotame, advantame, alitame and cyclamate. High intensity sweeteners also include natural sweeteners, for example: steviol glycosides extracted from leaves of stevia plants and Luo Han Guo fruit extracts.

The sweetener compositions disclosed herein are devoid of high intensity sweeteners. In some embodiments, the sweetener compositions of the present invention are devoid of any of saccharin, aspartame, acesulfame potassium (Ace-K), sucralose, neotame, advantame, alitame and cyclamate. In additional embodiments, the sweetener compositions of the present invention are devoid of any of steviol glycosides extracted from leaves of stevia plants and Luo Han Guo fruit extracts.

Fructose (herein—D-fructose) is a monosaccharide sugar identified by CAS Registry number 57-48-7. Fructose is characterized by higher sweetness yet lower glycemic index compared to sucrose. Fructose in a powder form is available commercially from various sources.

Erythritol is a non-caloric sugar alcohol (polyol) identified by CAS Registry number 149-32-6. Advantageously, erythritol does not cause tooth decay and also does not affect blood glucose levels. In addition, it normally does not cause gastrointestinal discomfort, a phenomenon associated with consumption of some other sugar alcohols. Erythritol is approved for use as a food additive throughout the world. Erythritol in a powder form is available commercially from various sources.

The anti-caking agent according to the present invention is preferably silicon dioxide, in particular, silicon dioxide, amorphous, identified as food additive E551, also termed ‘synthetic amorphous silica’ (SAS). SAS is comprised of aggregated nanosized primary particles. The forms of SAS used as a food additive E551 include fumed (pyrogenic) silica and precipitated silica. The anti-caking agent may be selected from the aforementioned forms and combinations thereof.

In some embodiments, the anti-caking agent is selected from precipitated amorphous silica and fumed silica. In some particular embodiments, the anti-caking agent is precipitated amorphous silica. In additional particular embodiments, the anti-caking agent is fumed silica.

In some embodiments, the amount of the anti-caking agent in the sweetener composition is up to 2% (w/w, with respect to the total weight of the composition). In additional embodiments, the amount of the anti-caking agent in the sweetener composition is up to 1% (w/w). In yet additional embodiments, the amount of the anti-caking agent is up to 0.1% (w/w). In yet additional embodiments, the amount of the anti-caking agent is in the range of 0.1%-1% (w/w). In yet additional embodiments, the amount of the anti-caking agent is 0.1% (w/w).

The sweetener composition of the present invention may not include an anti-caking agent. In some embodiments, the sweetener composition does not include silica.

In some embodiments, a sweetener composition in a powder form is provided, consisting essentially of: 40%-60% (w/w) fructose, 40%-60% (w/w) erythritol, and up to 2% (w/w) anti-caking agent.

In some embodiments, the sweetener composition is consisting of: 40%-60% (w/w) fructose, 40%-60% (w/w) erythritol, and up to 2% (w/w) anti-caking agent.

In some embodiments, the sweetener composition is consisting essentially of: 40%-60% (w/w) fructose, 40%-60% (w/w) erythritol, and up to 1% (w/w) anti-caking agent.

In some embodiments, the sweetener composition is consisting of: 40%-60% (w/w) fructose, 40%-60% (w/w) erythritol, and up to 1% (w/w) anti-caking agent.

In some embodiments, the sweetener composition is consisting essentially of: 40%-60% (w/w) fructose, 40%-60% (w/w) erythritol, and up to 0.1% (w/w) anti-caking agent.

In some embodiments, the sweetener composition is consisting of: 40%-60% (w/w) fructose, 40%-60% (w/w) erythritol, and up to 0.1% (w/w) anti-caking agent.

In some embodiments, a sweetener composition in a powder form is provided, consisting essentially of: 49%-49.95% (w/w) fructose; 49%-49.95% (w/w) erythritol, wherein the fructose and erythritol are present in the composition at a 1:1 weight ratio; and 0.1%-2% (w/w) anti-caking agent.

In some embodiments, the sweetener composition is consisting of: 49%-49.95% (w/w) fructose; 49%-49.95% (w/w) erythritol, wherein the fructose and erythritol are present in the composition at a 1:1 weight ratio; and 0.1%-2% (w/w) anti-caking agent.

In some embodiments, the sweetener composition is consisting of: 49.5%-49.95% (w/w) fructose; 49.5%-49.95% (w/w) erythritol, wherein the fructose and erythritol are present in the composition at a 1:1 weight ratio; and 0.1%-1% (w/w) anti-caking agent.

In some embodiments, the sweetener composition consists of 49.95% (w/w) fructose, 49.95% (w/w) erythritol, and 0.1% anti-caking agent.

In some particular embodiments, the sweetener composition consists of 49.95% (w/w) fructose, 49.95% (w/w) erythritol, and 0.1% silicon dioxide.

In some embodiments, a sweetener composition in a powder form is provided, comprising: 40%-60% (w/w) fructose, 40%-60% (w/w) erythritol; and up to 1% anti-caking agent, wherein the fructose and erythritol are the sole sweetening agents in the composition.

In some embodiments, a sweetener composition in a powder form is provided, comprising: 40%-60% (w/w) fructose, 40%-60% (w/w) erythritol; and up to 1% anti-caking agent, wherein the fructose and erythritol are the sole sweetening agents in the composition, and wherein the fructose and erythritol are present in the composition at a 1:1 weight ratio.

In some embodiments, a sweetener composition in a powder form is provided, comprising: 40%-60% (w/w) fructose, 40%-60% (w/w) erythritol; and up to 1% anti-caking agent, wherein the composition is devoid of high intensity sweeteners.

In some embodiments, a sweetener composition in a powder form is provided, comprising: 40%-60% (w/w) fructose, 40%-60% (w/w) erythritol; and up to 1% anti-caking agent, wherein the composition is devoid of high intensity sweeteners, and wherein the fructose and erythritol are present in the composition at a 1:1 weight ratio.

The sweetener compositions of the present invention are prepared, according to some embodiments, by mixing fructose, erythritol and an anti-caking agent, each in a powder form, to obtain a blend in which the components are distributed evenly. Typically, the anti-caking agent is first mixed with small amounts of fructose and/or erythritol, e.g. with several kilograms of fructose and/or erythritol to obtain an initial blend in which the components are distributed evenly. This initial blend is subsequently mixed with more fructose and erythritol to obtain the final blend according to the present invention. Alternatively, a third of the total amount of fructose, a third of the total amount of erythritol and a third of the total amount of the anti-caking agent are added to a blender. Next, another third of the total amount of each ingredient are added to the blender, and finally, the remaining amounts of each ingredient are added to the blender. The ingredients are then mixed in the blender to obtain a final blend in which they are distributed evenly.

According to some embodiments, the final blend is packaged as individual servings, each of 1-5 gr. total weight. In some particular embodiments, the sweetener composition is packaged as an individual serving of 1 gr. total weight. In additional particular embodiments, the sweetener composition is packaged as an individual serving of 5 gr. total weight. According to additional embodiments, the sweetener composition is packaged as a bag of between 0.5 kg to 1 kg. total weight, for example 0.5 kg, 0.75 kg or 1 kg total weight.

The present invention further provides a food product sweetened with the sweetener composition of the present invention. In some particular embodiments, the food product is a beverage. In additional particular embodiments, the food product is a pastry. As used herein, food products sweetened with the sweetener composition of the present invention encompass food products sweetened with a combination of fructose and erythritol, preferably at a 1:1 weight ratio, with no additional sweetening agents, in particular, with no high intensity sweeteners.

The following examples are presented in order to more fully illustrate certain embodiments of the invention. They should in no way, however, be construed as limiting the broad scope of the invention. One skilled in the art can readily devise many variations and modifications of the principles disclosed herein without departing from the scope of the invention.

### EXAMPLES

### Example 1

### Low-Calorie Sweetener Composition in a Powder Form

A sweetener composition in a powder form containing fructose and erythritol in a 1:1 weight ratio and an anti-caking agent was prepared. The sweetener composition consisted of 49.95% (w/w) fructose, 49.95% (w/w) erythritol and 0.1% (w/w) silicon dioxide (precipitated amorphous silica) as the anti-caking agent.

| Ingredient | Amounts | | Supplier |
|---|---|---|---|
| Fructose | 49.95 | kg | Fruitose ® Galam |
| Erythritol | 49.95 | kg | Baolingbao/Dongxiao |
| Anti-caking agent | 0.1 | kg | Solvay |

The ingredients (all in a powder form) were dry blended to obtain a homogeneous blend. The resulting blend was packaged into 0.75 kg. bags.

The sweetener composition has approximately half the amount of calories compared to regular table sugar (sucrose), with equivalent sweetness.

The sweetener composition was provided to a panel of 80 test subjects who agreed to consume the composition at home for a period of time of approximately 3 weeks. The sweetener composition was used by the tasters for baking, cooking and to sweeten hot and cold drinks.

The tasters indicated that foods and beverages sweetened with the sweetener composition had a palatable taste, with no significant aftertaste or bitterness or the like that are associated with high intensity sweeteners and other sugar substitutes.

The foregoing description of the specific embodiments will so fully reveal the general nature of the invention that others can, by applying current knowledge, readily modify and/or adapt for various applications such specific embodiments without undue experimentation and without departing from the generic concept, and therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed chemical structures and functions may take a variety of alternative forms without departing from the invention.

1. A sweetener composition in a powder form, consisting essentially of:
49%-49.95% (w/w) fructose;
49%-49.95% (w/w) erythritol, wherein the fructose and erythritol are present in the composition at a 1:1 weight ratio; and
0.1%-2% (w/w) anti-caking agent.

2. The sweetener composition of claim 1, wherein the composition consists of:
49.5%-49.95% (w/w) fructose;
49.5%-49.95% (w/w) erythritol, wherein the fructose and erythritol are present in the composition at a 1:1 weight ratio; and
0.1%-1% (w/w) anti-caking agent.

3. The sweetener composition of claim 1, consisting of 49.95% (w/w) fructose, 49.95% (w/w) erythritol, and 0.1% anti-caking agent.

4. A sweetener composition in a powder form, comprising:
40%-60% (w/w) fructose;
40%-60% (w/w) erythritol; and
up to 2% anti-caking agent,
wherein the fructose and erythritol are the sole sweetening agents in the composition.

5. The sweetener composition of claim 4, consisting of 40%-60% (w/w) fructose, 40%-60% (w/w) erythritol and up to 1° A anti-caking agent.

6. The sweetener composition of claim 4, consisting of 40%-60% (w/w) fructose, 40%-60% (w/w) erythritol and up to 0.1° A anti-caking agent.

7. A sweetener composition in a powder form, comprising:
40%-60% (w/w) fructose;
40%-60% (w/w) erythritol; and
up to 2% anti-caking agent,
wherein the composition is devoid of high intensity sweeteners.

8. The sweetener composition of claim 1, wherein the anti-caking agent is silicone dioxide.

9. The sweetener composition of claim 1, packaged as an individual serving of 1-5 gr. total weight.

10. The sweetener composition of claim 1, packaged as a bag of 0.5-1 kg total weight.

11. A food product sweetened with the sweetener composition of claim 1.

12. The food product of claim 11, wherein the food product is a beverage.

13. The food product of claim 11, wherein the food product is a pastry.
